(19) United States
(12) Patent Application Publication
(10) Pub. No.: US 2005/0196142 A1
(43) Pub. Date: Sep. 8, 2005

(54) Recording medium having a data structure for managing data streams associated with different languages and recording and reproducing methods and apparatuses

(76) Inventors: Sung Wan Park, Suwon-si (KR); Jea Yong Yoo, Seoul (KR); Kang Soo Seo, Anyang-si (KR); Byung Jin Kim, Seongnam-si (KR)

Correspondence Address: HARNESS, DICKEY & PIERCE, P.L.C., P.O. BOX 8910, RESTON, VA, 20195, US

(21) Appl. No.: 11/022,696

(22) Filed: Dec. 28, 2004

Related U.S. Application Data
(60) Provisional application No. 60/542,852, filed on Feb. 10, 2004.
(60) Provisional application No. 60/542,850, filed on Feb. 10, 2004.
(60) Provisional application No. 60/543,328, filed on Feb. 11, 2004.

(30) Foreign Application Priority Data
Mar. 9, 2004 (KR) 10-2004-0015864

(51) Int. Cl. H04N 5/783; H04N 5/781

(52) U.S. Cl. 386/69; 386/125; 386/95

(57) ABSTRACT

In the data structure for managing data streams associated with different languages, a playlist including at least one playitem for managing reproduction of a main data stream is provided. The playitem includes a table defining a list of data streams. The list of data streams includes the main data stream and a data stream of at least one type of supplemental data stream. The table includes language information on each supplemental data stream of the type of supplemental data stream, and the language information indicates a language associated with the supplemental data stream.

### CROSS-REFERENCE TO RELATED APPLICATIONS

This application claims the benefit of priority under 35 U.S.C. 119 on Korean Application No. 10-2004-0015864, filed on Mar. 9, 2004, which is hereby incorporated by reference in its entirety.

### BACKGROUND OF THE INVENTION

1. Field of the Invention

The present invention relates to high density recording media such as read-only blu-ray discs (BD-ROM).

2. Discussion of Related Art

Optical discs are widely used as an optical recording medium. Presently, of the optical discs, a new high density optical recording medium (HD-DVD), such as the Blu-ray Disc (hereafter called as “BD”), for recording and storing a large amount of high definition video and audio data is under development.

Currently, global standard technical specifications of the Blu-ray Disc (BD), a next generation HD-DVD technology, are being established as a next generation optical recording solution that can store amounts of data significantly surpassing present DVDs.

In relation to this, development of optical reproducing apparatuses for the Blu-ray Disc (BD) standards has also started. However, the Blu-ray Disc (BD) standards are not complete yet, and there has been difficulty in developing a complete optical reproducing apparatus.

Particularly, for effective reproduction of data from the Blu-ray Disc (BD), in addition to main AV data, various kinds of other data may be reproduced for the convenience of a user, such as supplementary or supplemental data (e.g., interactive graphics data, subtitle data, etc.) related to the main AV data. Accordingly, managing information should be provided for managing reproduction of the main data and the supplemental data. However, in the present Blu-ray Disc (BD) standards, because consolidated standards for managing the various data, particularly the supplemental data are not complete yet, there are many restrictions on the development of a Blu-ray Disc (BD) optical reproducing apparatus.

### SUMMARY OF THE INVENTION

A recording medium according to the present invention includes a data structure for managing data streams associated with different languages.

In one embodiment, the recording medium stores a playlist including at least one playitem for managing reproduction of a main data stream, and the playitem includes a table defining a list of data streams. The list of data streams includes the main data stream and a data stream of at least one type of supplemental data stream. The table including language information for each supplemental data stream of the type of supplemental data stream, and the language information indicates a language associated with the supplemental data stream.

For example, the type of supplemental data stream may be text subtitles, interactive graphics, presentation graphics, etc.

In one embodiment, the table includes a type indicator for each data stream indicating whether the data stream is used by the playitem or a subpath of the playitem.

In another embodiment, the recording medium stores a clip information file including at least a program information data structure. The program information data structure provides stream coding information for each data stream. The stream coding information for at least one of the data streams includes language information indicating a language associated with the data stream.

In one embodiment, the coding information for each data stream also includes a type indicator indicating the type of data stream, and when the type indicator indicates a text subtitle data stream, the coding information includes the language information.

The present invention further provides apparatuses and methods for recording and reproducing the data structure according to the present invention.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention.

In the drawings;

FIG. 1 illustrates a file structure for managing various data on a disc in accordance with an example embodiment of the present invention;

FIG. 2 illustrates a format of a disc on which the file structure of FIG. 1 is recorded in accordance with an example embodiment of the present invention;

FIG. 3 illustrates a data structure and method for recording reproduction management information of main AV data and supplemental data streams;

FIGS. 4A and 4B illustrate diagrams showing examples in which a main AV stream and supplemental data, particularly, a text subtitle are provided at the same time;

FIG. 5 illustrates a diagram showing a ProgramInfo( ) data structure syntax for supplemental data clip information in accordance with an example embodiment of the present invention;

FIG. 6 illustrates a data structure syntax for a subplayitem in accordance with an example embodiment of the present invention;

FIG. 7 illustrates a data structure syntax for a subplayitem in accordance with another example embodiment of the present invention;

FIG. 8 illustrates a portion of the data structure syntax for the “STN_table( )” in a playitem, and further illustrates the data structure syntax for the “stream_entry( )” in the “STN_table( )”; and

FIG. 9 illustrates a block diagram of an optical recording and reproduction apparatus in accordance with an example embodiment of the present invention.

### DETAILED DESCRIPTION OF THE EXEMPLARY EMBODIMENTS

Reference will now be made in detail to the embodiments of the present invention, examples of which are illustrated in the accompanying drawings. Though words used in the present invention are selected from widely used general words, there are words the applicant has selected at his discretion and the detailed meanings of these words are described in relevant parts of the description of the present invention. As such, the present invention is to be understood by meanings of the words provided in the disclosure.

In relation to above, main data in the present invention means main data or information on the recording medium (e.g., an optical disc) such as a title of video and audio data an author provides to a user, in general, recorded in the MPEG2 format, and often referred to as a main AV stream.

Supplementary or supplemental data means all data related to the main data provided to a user for convenience of reproduction, including, for example, an auxiliary audio stream as background music; interactive graphic stream, such as PopUp menu, a click sound interactive with the user; and subtitle information such as caption information and words of a song.

Therefore, depending on the nature of the supplemental data, the supplemental data is recorded multiplexed with a main AV stream in the MPEG2 format, or is recorded as a stream file in the MPEG2 or other format independent from the main AV stream.

Caption information is information generally displayed at one side of a screen when the user selects a subtitle of a language the recording medium supports and intends to watch a video (the main AV data) with a caption of that language.

The PopUp menu, introduced for providing different menus depending on the nature of data in an associated reproduction unit, is menu information provided in a small window of a display screen without changing reproduction of a picture under reproduction. The PopUp menu may be displayed overlapping the picture under reproduction. Because of this, the menu information is referred to as a “PopUp” menu.

The click sound is a brief sound provided upon selection of a menu button, or a shift in selection, and calls a user's attention to the fact that a selection has been made. Depending on the use of the click sound, the click sound is sometimes referred to as a “menu sound”.

In the present invention, the “subtitle” as supplemental data may be caption information, presentation graphic information, etc. such as the text of a song. Therefore, the subtitle may be written in various formats such as MPEG2 transport (TS) packets, bit-map form of binary format, or text data (e.g., character data). A subtitle recorded in the form of text data may be referred to as a “text subtitle”.

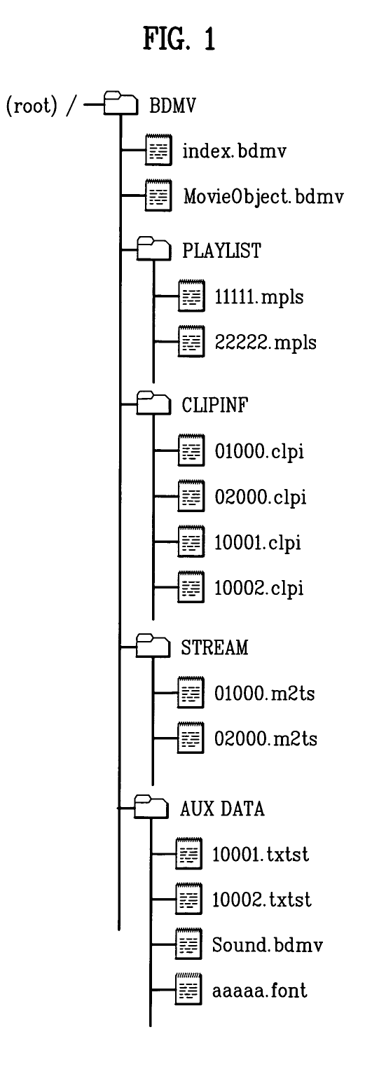

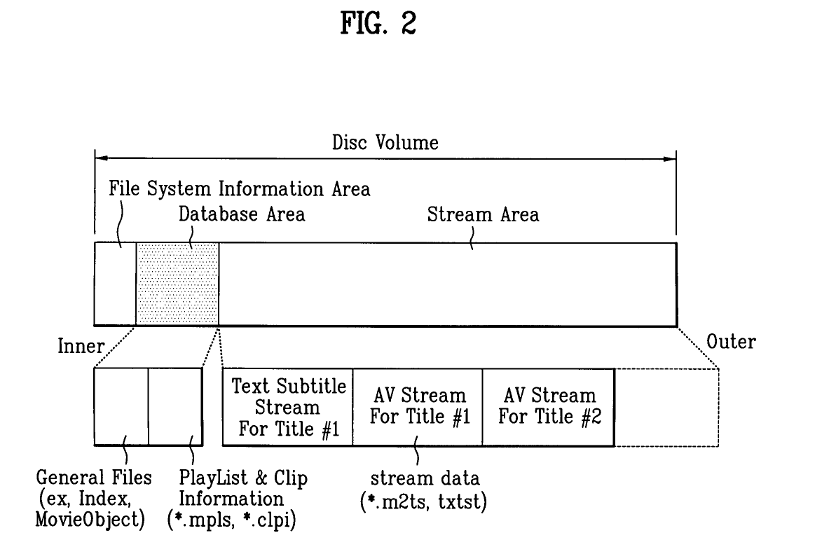

A format for recording main data and supplemental data on the recording medium such as a, BD disc, and a file structure for managing the data will be described in detail with reference to FIGS. 1 and 2.

FIG. 1 illustrates a file structure for managing various data on a disc in accordance with an example embodiment of the present invention. As shown, at least one BD directory BDMV exists beneath one root directory. In the BD directory BDMV, an index file index.bdmv and an object file MovieObject.bdmv are included as general file (upper file) information to secure interactivity with a user. Moreover, a playlist directory PLAYLIST, clipinfo directory CLIPINF, stream directory STREAM, and auxiliary data directory AUX DATA are included in the BD directory BMDV.

Files for video and audio streams, which are called ‘main AV stream’, recorded in a disc according to specific formats and auxiliary streams such as text subtitle (hereinafter called text subtitle stream) independently exist in the stream directory STREAM. Because the text subtitle streams files and AV stream files are recorded in the MPEG2 format (e.g., MPEG2 transport packets), ‘*.m2ts’ is used the extension name of each stream file (e.g., 01000.m2ts, 02000.m2ts, and 10001.m2ts). Alternatively, in case of the text subtitle stream file, ‘*.txtst’ may be used as the file extension name since the text subtitle stream has auxiliary or supplemental data features different from that of the main AV stream, for example.

In the BD specifications, streams may be called a clip stream file. Relating to the present invention, the text subtitle data will exist in the form of a separate stream file from the AV stream file. For example in FIG. 1, the text subtitle data may exist as the text subtitle stream file 10001.m2ts (not shown) or 10001.txtst (not shown in the STREAM directory, but in the AUX DATA directory for the purposes of example only).

The clipinfo (or clip information) directory CLIPINF includes clip information or clipinfo files *.clpi, each having a one-to-one correspondence with a stream file. A clipinfo file *.clpi has attribute information and timing information of the corresponding stream file and serves as a management file. More specifically, the information in the clipinfo file includes mapping information that enables mapping of a Presentation Time Stamp (PTS) to a Source Packet Number (SPN) of a source packet in the corresponding stream file. This map is referred to as an Entry Point Map or “EP_map”.

A stream file and the corresponding clipinfo file may be called a “clip”, collectively. Accordingly, the file “01000.clpi” in the clipinfo directory CLIPINF has attribute information and timing information on the file “01000.m2ts” in the stream directory STREAM, and the files “01000.clpi” and “01000.m2ts” form a clip.

The playlist directory PLAYLIST includes playlist files *.mpls, each having at least one playitem PlayItem designating a playing interval of a particular clip. The playitem PlayItem includes timing information on a play start time In-Time and play end time Out-Time of a particular clip for playback, and identifies the clip by providing the clip information file name in a Clip_Information_File_name field. Using the PTS information in the In-Time and Out-time information, the EP map of the named clipinfo file allows a particular stream address or position (e.g., SPN) of the corresponding stream file to be searched for and obtained such that reproduction of the playitem results in reproduction of the clip.

The playlist file *.mpls serves as a basic management file for playing a desired clip by providing at least one playitem PlayItem. Moreover, the playlist file *.mpls may also provide a sub-playitem SubPlayItem for managing reproduction of, for example, supplemental data, which may be reproduced synchronized or non-synchronized with the playitem PlayItem. For instance, in the case of including a SubPlayItem for playing back text subtitles, the corresponding SubPlayItem is synchronized with the PlayItem to play back the data. Yet, in the case of including a SubPlayItem for playing back audio data for a browsable slide show, the corresponding SubPlayItem is not synchronized with the PlayItem.

In the present invention, auxiliary or supplemental data including text subtitles may managed by SubPlayItems for example, which will be explained in detail below.

The auxiliary data directory AUX DATA is an area for separately recording auxiliary data files for the playback. For instance, in order to support more user-friendly playback, a sound file Sound.bmdv for providing a click sound, a font file *.font employed with text subtitle playback, and the like are recorded therein.

Accordingly, the text subtitle stream 10001.txtst, which is a kind of auxiliary data, may be recording in the auxiliary data directory AUX DATA as shown in FIG. 1.

Moreover, in the above-explained BD directory BDMV, the index file index.bdmv and the object file MovieObject.bdmv exist as general files to secure interactivity with a user. The index file index.bdmv has an index table providing menu information and title information the user can select. The MovieObject.bdmv provides navigation commands for, for example, executing a playlist, and may be called from a selection made in the index table.

As shown in FIG. 2, the disc volume of a BD-ROM is organized into a File System Information Area, a Database Area, and a Stream Area. The File System Information Area stores system information for managing the disc. The Database Area includes a general files area and a playlist and clip information area. The general files area stores general files such as the index.bdmv file and the MovieObject.bdmv file. The playlist and clip information area stores the PLAYLIST directory and the CLIPINF directory. The main data and the supplemental data (STREAM and AUXDATA directories) are recorded in the Stream Area. According to this, a reproducing apparatus determines the main data and the supplementary data desired to reproduce, by using file information in the Database Area and/or stream management information in the Stream Area.

Hence, via the file information within the database area and/or the stream management information within the stream file area (Stream Area), a user decides the main and auxiliary data to be reproduced and their reproducing method.

In the following description, management information data structures for managing reproduction of supplemental data such as text subtitles will be described, and methods of recording and reproducing the management information and the supplemental data using the recorded management information will be explained.

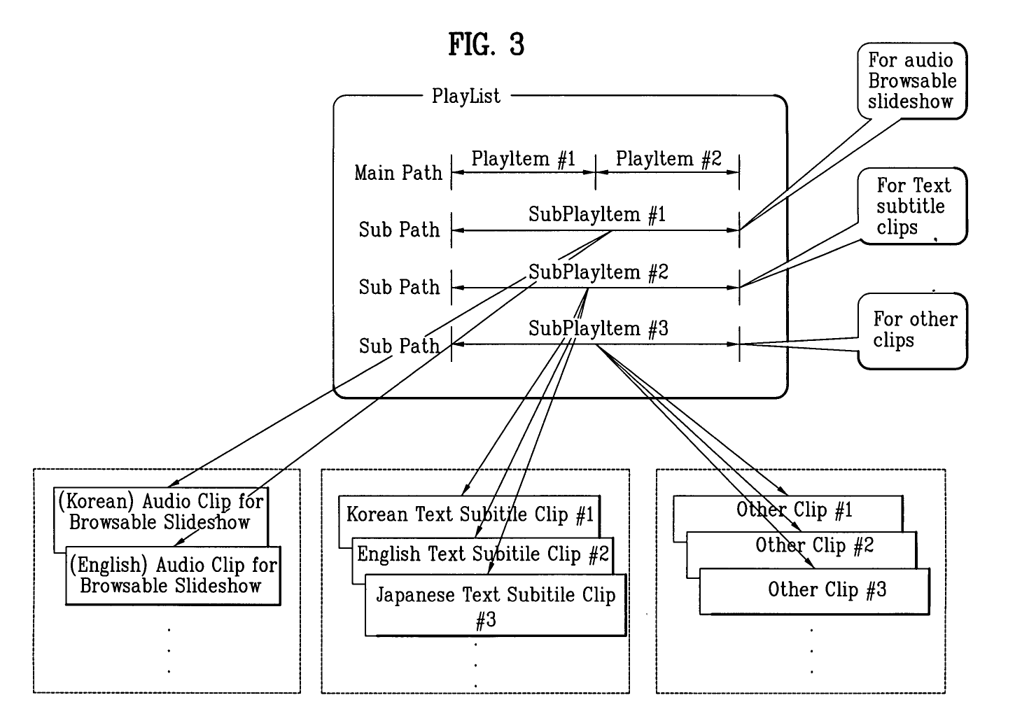

FIG. 3 illustrates a data structure and method for recording reproduction management information of main AV data and supplemental data streams. As shown, a particular title for reproduction may be managed by a playlist file PlayList, and the main AV data is recorded in a main clip Main Clip (not shown). More specifically, in this instance, the one main clip Main Clip may be managed by a plurality of playitems PlayItem #1 and PlayItem #2. Also, different main clips Main Clip may be managed by a plurality of playitems within one playlist PlayList.

The supplemental data that supplements the main AV data are recorded in separate clips and managed by subplayitems, for example, SubPlayltems#1, #2 and #3. As shown, a SubPath exists for each supplemental data type and the subplayitems may be organized by SubPath.

That is, the supplemental data is sorted according to clip types, and managed by a plurality of subplayitems. For example, an audio clip (e.g., in Korean or English) for a browsable slide show may be a clip managed by a first subplayitem SubPlayItem #1 in one SubPath, and a plurality of text subtitle clips Text Subtitle Clips #1, #2 and #3 for supporting caption information of Korean, English, Japanese, respectively, may be clips managed by a subplayitem SubPlayItem #2 in another SubPath. Of the supplementary data, a plurality of other clips (e.g., PopUp, etc.) excluding the audio clip and the text subtitle clips may be managed by a subplayitem SubPlayItem #3 in yet another SubPath.

Thus, an example file structure of the present invention has a structure in which the clips are managed by a subplayitem for each clip type (e.g., each supplemental data or SubPath type).

The playitem PlayItem in the PlayList has reproduction management information for reproducing the main data, and the subplayitems SubPlayItem have reproduction management information for reproducing the supplemental data. Particularly, as described before, as part of the reproduction managing information, the playitem and subplayitems provide reproduction starting time In-time and a reproduction end time Out-Time for each associated clip.

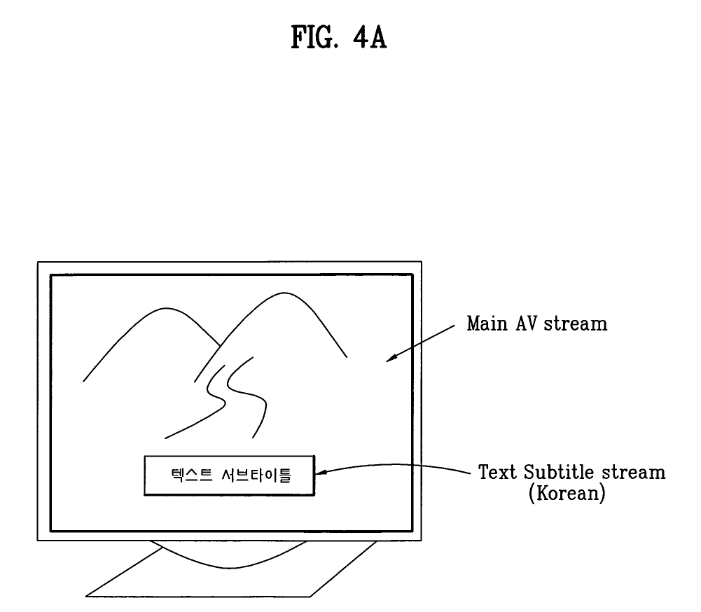

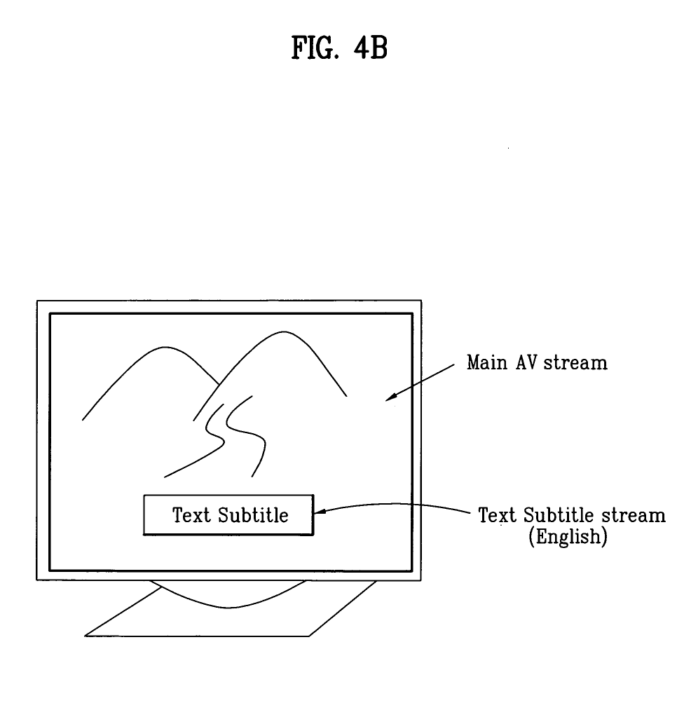

FIGS. 4A and 4B illustrate diagrams showing examples in which a main AV stream and supplemental data, particularly, a text subtitle are provided at the same time. FIG. 4A illustrates an example of a case when a text subtitle is in Korean as the caption information, and FIG. 4B illustrates an example of a case when a text subtitle is in English as the caption information. The text subtitles of Korean and English exist as independent clips, and are displayed, based on user selection, at one side of the display screen, separate from and overlapping with the main AV stream.

Next, the syntax of the data structures according to embodiments of the present invention will be described.

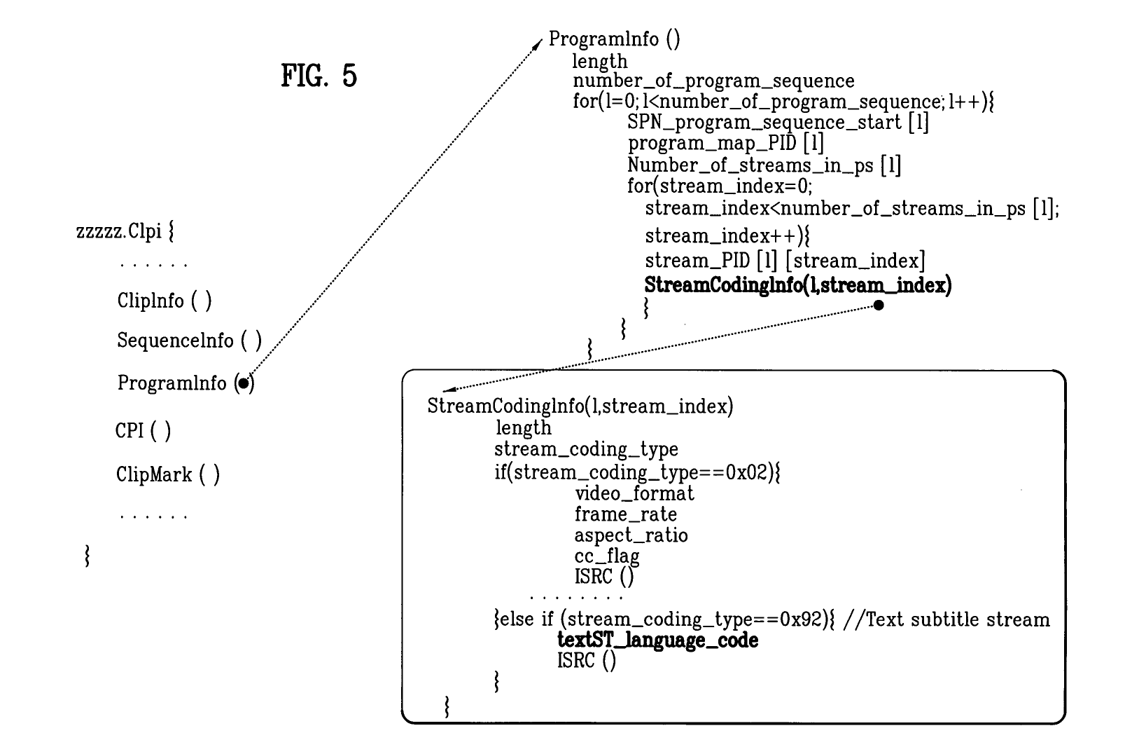

FIG. 5 illustrates a diagram showing a ProgramInfo( ) data structure syntax for supplemental data clip information in accordance with an example embodiment of the present invention. As such, FIG. 5 also provides a method for selecting clips using a subplayitem according to the attribute information in the clip and a method for including language information in the clip information of a text subtitle clip. As shown, the clip info file zzzzz.Clpi provides application information and time information on respective stream files *.m2ts, *.txst, etc. using five data structure objects: ClipInfo( ), SequenceInfo( ), ProgramInfo( ), CPI( ), and ClipMark( ).

Of the five data structure objects of the clip info file zzzzz.Clpi, the ProgramInfo( ) data structure has a length field, and a “number_of_program_sequence” field. The length field indicates the length of the ProgramInfo data structure, and the “number_of_program_sequence” field indicates the number of program sequences managed by the ProgramInfo data structure. For each program sequence, indexed by l, the data structure includes an “SPN_program_sequence_start[l]” field, a “program_map_PID[l]” field, and a “number_of_streams_in_ps[l]” field. The “SPN_program_sequence_start[l]” field indicates the source packet (SPN) of the start of the lth program sequence. The “program_map_PID[l]” field indicates the PID value of the transport packets that contain the program_map_section of the lth program sequence. The “Number_of_streams_in_ps[l]” field indicates the number of elementary streams in the lth program sequence. For each stream, indexed by a stream_index, the data structure further includes a “stream_PID (l, stream_index)” field, a “StreamCodingInfo (l, stream_index)” data structure, and the like. The stream_PID[l][stream_index)” data structure indicates the PID value of the transport packets for the elementary stream designated by the stream index stream_index for the program sequence designated by the sequence index l. The “StreamCodingInfo (l, stream_index)” data structure has coding information on an elementary stream of the main AV stream and the supplementary data stream.

The “StreamCodingInfo (l, stream_index)” data structure, having coding information on the elementary stream includes a “length” field for indicating a length of the “StreamCodingInfo (l, stream_index)” field, and a “stream_coding_type” field for indicating a coding type of the elementary stream. This latter field has coding information on various forms of streams depending on the coding type of the elementary stream.

For example, the stream_coding_type of 0x02 indicates coding information of an MPEG2 video stream, the stream_coding_type of 0x80 indicates coding information of HDTV LPCM audio, the stream_coding_type of 0x81 indicates coding information of an Dolby AC-3 audio, the stream_coding_type of 0x91 indicates coding information of an interactive graphics stream, the stream_coding_type of 0x90 indicates coding information of a presentation graphic stream, and the stream_coding_type of 0x92 indicates coding information of a text subtitle stream (for convenience of description, FIG. 5 illustrates cases of the stream_coding_type of 0x02, and 0x92).

In the case of stream_coding_type=0x02, video_format, frame_rate, aspect_ratio, cc_flag and ISRC( ) fields are provided. The first three fields are self-explanatory, the cc_flag indicates whether Line 21 information of a 525/60 TV system is included in the stream, and the ISRC field indicates the applicable International Standard Recording Code.

In the case of the stream_coding_type of 0x92 (i.e., in the case of the text subtitle stream), language information on the text subtitle clip may be included by using the “textST_language_code” field. The “textST_language_code” field indicates the language of the subtitle using a codeword of 8*2 bit.

As aforementioned, by inserting language information via the language_code in the text subtitle clip information, the clip information of the text subtitle may be first retrieved and stored, and then used for selectively reproducing a language subtitle the user wants during reproduction of, for example, main AV data.

This methodology may be used to select between the plurality of clips managed by a single sub-playitem such as in the case of selecting a language of the audio clip for a browsable slide show, selecting the language of a text subtitle, etc.

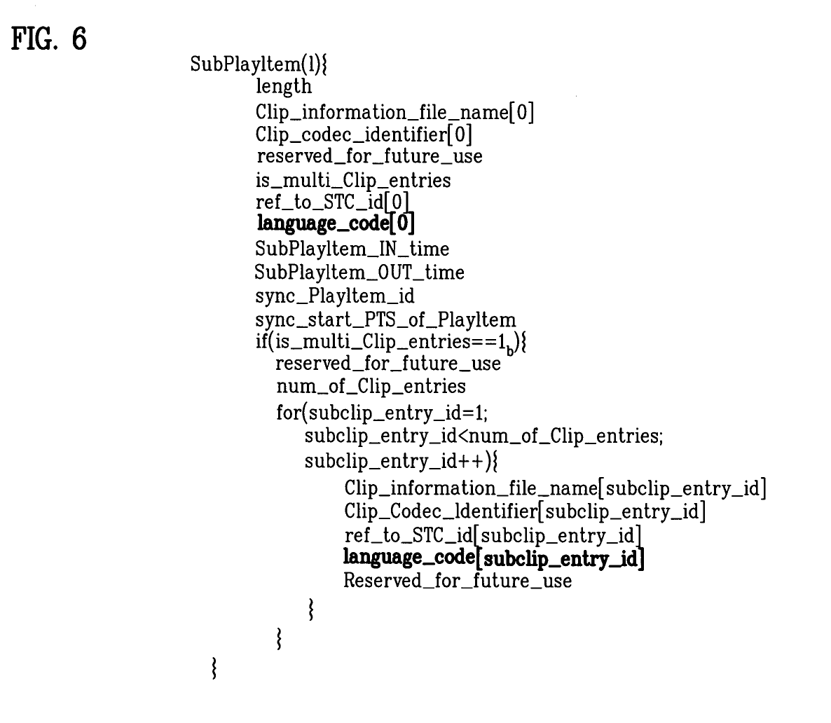

FIG. 6 illustrates a data structure syntax for a subplayitem in accordance with an example embodiment of the present invention. As shown, the syntax of the subplayitem “SubPlayItem(1)” includes a length field indicating the length of the subplayitem, a “Clip_Information_file_name[0]” field identifying a first or only clip information file of a clip managed by the subplayitem, a “SubPlayItem_IN_time” field and “SubPlayItem_OUT_time” for designating a stream file starting time and end time as described above, a “Clip_codec_identifier[0]” field having a value of “m2ts” according to ISO 646, a “ref_to_STC_id[0]” field for indicating an stc_id value for an STC sequence of the clip, and a “sync_PlayItem_id” field and a “sync_start_PTS_of_PlayItem” field for synchronizing the subplayitem with a playitem, if valid.

The subplayitem syntax also includes one bit information field called “is_multi_Clip_entries” recorded thereon as information for identifying whether a plurality of clips of supplementary data are managed by the subplayitem. For example, when “is_multi_Clip_entries”=1b, the subplayitem manages a plurality of clips, and when “is_multi_Clip_entries”=0b, the subplayitem manages a single clip.

If the subplayitem manages a plurality of clips (i.e., “is_multi_Clip_entries”=1b) then the syntax of the subplayitem further includes a “num_of_Clip_entries” field indicating the number of clips managed by the subplayitem. When a plurality of clips are managed, the clips are referred to as subclips in the subplayitem syntax. For the second clip (i.e., subclip_entry_id=1) through the last subclip, the syntax of the subplayitem provides a “Clip_Information_file_name[subclip_entry_id]” field, a “Clip_Codec_Identifier[subclip_entry_id]” field, and a “ref_to_STC_id[subclip_entry_id]” field. This information for the first clip having been provided in the first portion of the subplayitem syntax where the index (e.g., subclip_entry_id) was 0”.

Furthermore, if, for example, the subplayitem manages text subtitles, then a “language_code” field is included in the subplayitem syntax for each clip managed by the subplayitem. Therefore, language information of a subclip with a subclip entry identifier=0 is recorded by a “language_code[0]” field, and language information on the remaining plurality of text subtitles in the subplayitem are recorded by “language_code[subclip_entry_id]” as shown in FIG. 6. The language code of a subclip indicates the language of the text subtitle represented by that subclip.

According to the above data structures and methods, various language clips of a text subtitle are represented, and it is apparent that the “language_code” field may be used in providing language selection information to a user for selecting and reproducing a text subtitle.

Accordingly, the “language_code” field is used not only for providing language information of the text subtitle, but also for providing information to make possible the selection between a plurality of clips according to the attribute of the subplayitem.

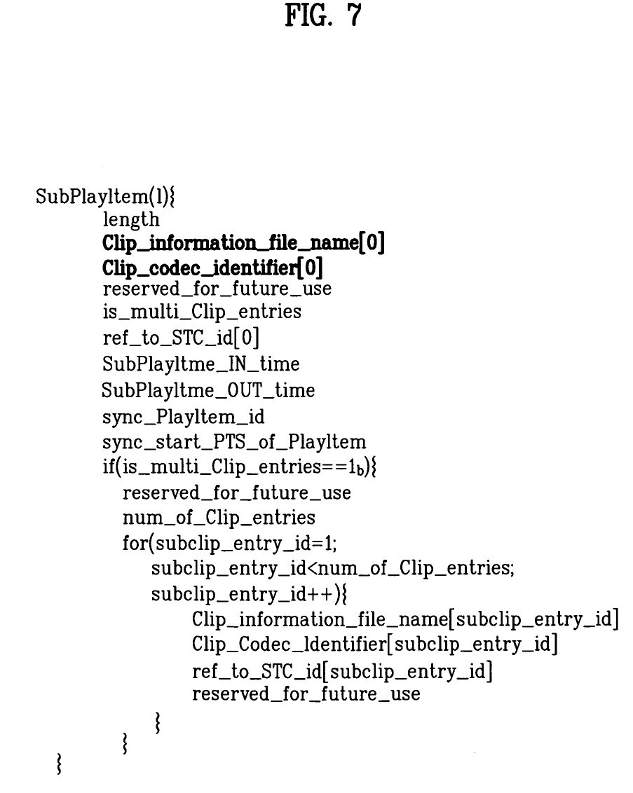

FIG. 7 illustrates a data structures syntax for a subplayitem in accordance with another example embodiment of the present invention. The syntax of FIG. 7 is the same as the syntax of FIG. 6 except that the language codes have been eliminated. Furthermore, in the embodiment of FIG. 7, a rule is applied to the name of each clip file by changing the contents of the “Clip_information_file_name[0]” field and the “Clip_codec_identifier[0]” field.

Normally, a file name of “nnnnn” (0≦n≦9) is provided in the “Clip_information_file_name[i]” field, and “m2ts” is provided in the “Clip_codec_identifier[i]” field. However, according to this embodiment of the present invention, when the subplayitem manages text subtitles, “xxnnn” is provided as the “Clip_information_file_name[i]” field where “xx” is the language code (ISO 646) of two bytes and “text” is provided in the “Clip_codec_identifier[i]” field. As another example, “xxnnn” and “show” in a case of an audio clip for the browsable show may be respectively inserted into the two fields.

Therefore, according this data structure, a method of selectively reproducing clips managed by the subplayitem has advantages of distinguishing files by using, for example, the language information (in the case of text subtitles) in the “Clip_information_file_name[i]” and “Clip_codec_identifier[i]” fields. Furthermore, this information may be used to distinguish between the types of supplemental data or clips managed by different subplayitems.

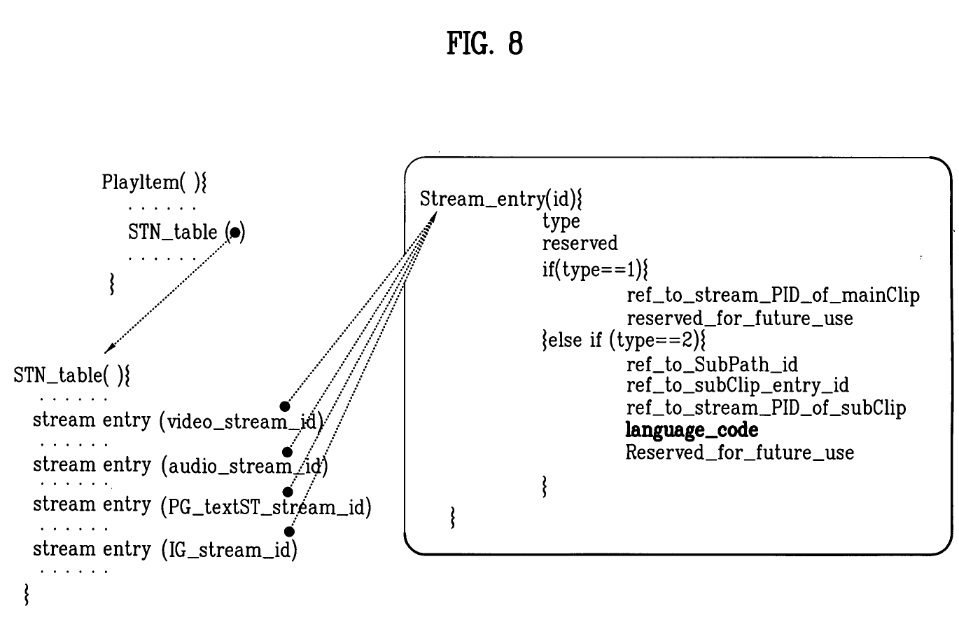

FIG. 8 illustrates a portion of the data structure syntax for a “STN_table( )” in a playitem, and further illustrates the data structure syntax for the “stream_entry( )” in the “STN_table( )”. As illustrated in FIG. 8, the syntax of a playitem includes an “STN_table( )” that defines a list of the elementary streams selectable during the reproduction of the playitem.

For example, FIG. 8 illustrates that the “STN_table( )” may define elementary streams for video (e.g., the video of the main AV stream), audio (e.g., the audio of the main AV stream), text subtitle presentation graphics, interactive graphics, etc. More specifically, the “STN_table( )” includes a “stream_entry(id)” data structure for each type of elementary streams. Each “stream_entry(id)” data structure is distinguished from one another by the indexing identifier “id”.

The syntax of the “stream_entry(id)” data structure includes a “type” field indicating whether the “stream_entry(id)” is for a main AV stream managed by a playitem or a supplemental data stream managed by a subplayitem. Stated another way, the “type” field indicates whether the data stream is used by the playitem or a subpath. For example, in one embodiment, when the “stream_entry(id)” is for a main AV stream, the “type” is set to 1, and when the “stream_entry(id)” is for a supplemental data stream, the “type” is set to 2.

When the “stream_entry(id)” is “type” equal to one, the “stream_entry(id)” includes a “ref_to_stream_PID_of_mainClip” field indicating the PID (packet identifier) in the transport packets of the main AV stream.

When the “stream_entry(id)” is “type” equal to two, the “stream_entry(id)” includes a “ref_to_SubPath_id” field, a “ref_to_subClip_entry_id” field, a “ref_to_stream_PID_of_subClip” field and a “language_code” field. The “ref_to_SubPath_id” field provides an identifier of the subpath to which the subplayitem and the stream associated with this “stream_entry(id)” belongs. The “ref_to_subClip_entry_id” field indicates the subclip entry id for this stream as discussed above with respect to FIG. 6. The “ref_to_stream_PID_of_subClip” field indicates the PID of the transport packets forming the supplemental data stream associated with this “stream_entry(id)” when the stream is an MPEG2 stream. The “language_code” indicates the language of the supplemental data stream associated with this “stream_entry(id)”.

Accordingly, a playitem, by virtue of the “STN_table( )” included in the playitem, includes information identifying the main AV stream of the playitem and the supplemental data streams associated with the main AV stream. The playitem, by virtue of the “STN_table( )” also includes information on the languages supported by each type of supplemental data stream; for example, an interactive graphics stream, subtitle stream, etc. And, this language information may be used as the method for selecting a supplemental data stream of a language requested by a user.

As will be appreciated, the “language_code” field may be used to provide information for selecting between a plurality of different language clips managed by a subplayitem.

As discussed above, embodiments of the present invention has a data structure wherein a plurality of clips exists independently and are managed by subplayitems such that one subplayitem manages each type of supplemental data.

For distinguishing the plurality of clips of different languages such as a plurality of different language subtitle clips managed by a subplayitem, language information may be provided in the clip information. During reproduction, this clip information may be retrieved to obtain and store the language of each clip so as to permit selective reproduction of the clips based on a language the user wants.

Additionally, or alternatively, for distinguishing the plurality of clips of different languages such as a plurality of different language subtitle clips managed by a subplayitem, language information may be provided in the information area of the subplayitem. During reproduction, this subplayitem information may be retrieved to obtain and store the language of each clip so as to permit selective reproduction of the clips based on a language the user wants.

Additionally, or alternatively, for distinguishing the plurality of clips of different languages such as a plurality of different language subtitle clips managed by a subplayitem, language information may be provided in the name of each clip file. For example, in one of the above-described embodiments, two bytes of each clip file name are used as the language code. During reproduction, this information may be retrieved to obtain and store the language of each clip so as to permit selective reproduction of the clips based on a language the user wants.

Additionally, or alternatively, for distinguishing the plurality of clips of different languages such as a plurality of different language subtitle clips managed by a subplayitem, language information may be provided in the playitem (e.g., the STN_table( )). During reproduction, this information may be retrieved to obtain and store the language of each clip so as to permit selective reproduction of the clips based on a language the user wants.

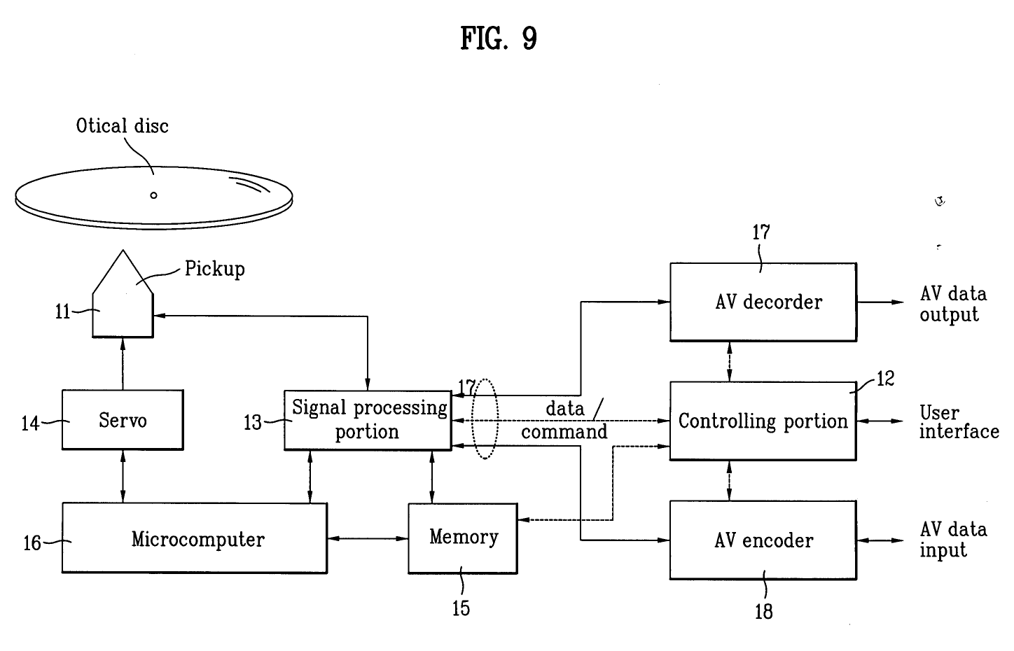

FIG. 9 illustrates an optical recording and reproduction apparatus in accordance with an embodiment of the present invention. As shown, the apparatus includes a pickup portion 11 (an optical pick-up) for reading managing information, main data and supplemental data recorded on the optical disc; a servo 14 for controlling operation of the pickup portion 11; a signal processing portion 13 for restoring a reproduced signal received from the pickup portion 11 into a desired signal value, or demodulating a signal-to-be-recorded into a signal to be written on the optical disc; a memory 15 for preloading and temporary storage of reproduction managing information including the supplementary data; and a microcomputer 16 for controlling the above operations.

In relation to above, in the present invention, the memory 15 represents various storage means (RAM, buffer, and the like) that may exist in the optical recording and reproduction apparatus, and it is apparent that the memory 15 may be replaced with a plurality of storage devices of different types.

The apparatus further includes, as shown, an AV decoder 17 that decodes the output data, and provides the decoded output data to a user under the control of a controlling portion 12 (e.g., a processor). Also, an AV encoder 18 converts an input signal into a signal of a particular format, for an example, the MPEG2 TS transport stream, and provides the encoded signal to the signal processing portion 13, under the control of the controlling portion 12, to write the signal on the optical disc.

The controlling portion 12, a portion for controlling operation of theentire optical recording and reproduction apparatus, reads the corresponding playitem and the subplayitem information in the playlist file in response to a user's instruction for reproducing a particular title (e.g., a main AV stream) received via a user interface. The controlling portion 12 controls the apparatus to reproduce the playitem PlayItem and the subplayitem SubPlayItem according to the reproduction management information included in the read playitem PlayItem and subplayitem SubPlayItem information as discussed above with respect to FIGS. 1-8.

For example, in accordance with one embodiment of the present invention, the clip information of text subtitles may be stored in the memory 15 by pre-loading, and selectively reproduced according to the language the user selects.

As another example, reproduction may be selectively performed according to the selection of the user by referring to the text subtitle language information included in the subplayitem, the clip information file name, and/or the playitem.

The controlling portion 12 also controls the apparatus to record the data structures (including the language information) discussed above with respect to FIGS. 1-8. A portion of this management information may be received via the user interface and sent to the signal processing portion 13 for writing onto the optical disc.

While the invention has been disclosed with respect to a limited number of embodiments, those skilled in the art, having the benefit of this disclosure, will appreciate numerous modifications and variations there from. For example, while described with respect to a Blu-ray ROM optical disk in several instances, the present invention is not limited to this standard of optical disk or to optical disks. It is intended that all such modifications and variations fall within the spirit and scope of the invention.

1. A recording medium having a data structure for managing data streams associated with different languages, comprising:
a recording area recording a playlist, the playlist including at least one playitem for managing reproduction of a main data stream, the playitem including a table defining a list of data streams including the main data stream and at least one type of supplemental data stream, the table including language information on each supplemental data stream of the type of supplemental data stream, the language information indicating a language associated with the supplemental data stream.

2. The recording medium of claim 1, wherein the type of supplemental data stream is text subtitles.

3. The recording medium of claim 1, wherein the type of supplemental data stream is interactive graphics.

4. The recording medium of claim 1, wherein the type of supplemental data stream is presentation graphics.

5. The recording medium of claim 1, wherein the table includes a type indicator for each data stream indicating whether the data stream is a main or supplemental data stream.

6. The recording medium of claim 1, wherein the table includes a type indicator for each data stream indicating whether the data stream is used by the playitem or a subpath of the playitem.

7. The recording medium of claim 1, wherein the table includes a type indicator for each data stream indicating whether the data stream is used by the playitem or a subplayitem.

8. The recording medium of claim 1, wherein the language information is a language code.

9. The recording medium of claim 1, wherein the table includes a data structure for each data stream, the data structure includes a type indicator indicating whether the data stream is used by the playitem or a subpath of the playitem, and when the type indicator indicates the data stream is used by a subpath, the data structure includes the language information.

10. The recording medium of claim 1, wherein the language information is a language code.

11. The recording medium of claim 1, wherein the table includes at least one data structure for each data stream, each data structure including a field that indicates a packet identifier of transport packets forming the data stream.

12. The recording medium of claim 1, wherein the table includes at least one data structure for each data stream, each data structure for a supplemental data stream including a field that indicates a subpath identifier of a subpath to which the supplemental data stream belongs.

13. A method of reproducing a data structure for managing data streams associated with different languages from a recording medium, comprising:
reproducing a playlist from the recording medium, the playlist including at least one playitem for managing reproduction of a main data stream, the playitem including a table defining a list of data streams including the main data stream and at least one type of supplemental data stream, the table including language information on each supplemental data stream of the type of supplemental data stream, the language information indicating a language associated with the supplemental data stream.

14. The method of claim 13, further comprising:
selectively reproducing a supplemental data stream based on the language information and input received from a user.

15. A method of recording a data structure for managing data streams associated with different languages on a recording medium, comprising:
recording a playlist on the recording medium, the playlist including at least one playitem for managing reproduction of a main data stream, the playitem including a table defining a list of data streams including the main data stream and at least one type of supplemental data stream, the table including language information on each supplemental data stream of the type of supplemental data stream, the language information indicating a language associated with the supplemental data stream.

16. An apparatus for reproducing a data structure for managing data streams associated with different languages from a recording medium, comprising:
a driver for driving an optical reproducing device to reproduce data recorded on the recording medium; and
a controller for controlling the driver to reproduce a playlist from the recording medium, the playlist including at least one playitem for managing reproduction of a main data stream, the playitem including a table defining a list of data streams including the main data stream and at least one type of supplemental data stream, the table including language information on each supplemental data stream of the type of supplemental data stream, the language information indicating a language associated with the supplemental data stream.

17. The method of claim 16, wherein the controller controls the driver to selectively reproduce a supplemental data stream based on the language information and input received from a user.

18. An apparatus for recording a data structure for managing data streams associated with different languages on a recording medium, comprising:
a driver for driving an optical recording device to record data on the recording medium;
a controller for controlling the driver to record a playlist on the recording medium, the playlist including at least one playitem for managing reproduction of a main data stream, the playitem including a table defining a list of data streams including the main data stream and at least one type of supplemental data stream, the table including language information on each supplemental data stream of the type of supplemental data stream, the language information indicating a language associated with the supplemental data stream.

19. A recording medium having a data structure for managing data streams associated with different languages, comprising:
a recording area recording a clip information file, the clip information file including at least a program information data structure, the program information data structure providing stream coding information for each data stream, the stream coding information for at least one of the data streams including language information indicating a language associated with the data stream.

20. The recording medium of claim 19, wherein the stream coding information for each data stream includes a type indicator indicating the type of data stream.

21. The recording medium of claim 20, wherein when the type indicator indicates a text subtitle data stream, the coding information includes the language information.

22. The recording medium of claim 21, wherein the language information is a language code.

23. The recording medium of claim 19, wherein the language information is a language code.
